(19) United States
(12) Patent Application Publication
(10) Pub. No.: US 2014/0122336 A1
(43) Pub. Date: May 1, 2014

(54) METHODS AND SYSTEMS FOR MODIFYING A STATUS OF A PAYMENT CARD

(71) Applicant: MASTERCARD INTERNATIONAL INCORPORATED, Purchase, NY (US)

(72) Inventors: Daniel Jeremy Rich, San Diego, CA (US); Jeffrey Leo Altemueller, Marthasville, MO (US); Alex Inovenkov, O'Fallon, MO (US); Richard Barry Husa, St. Charles, MO (US); Victor Gabriel Chininin-Buele, Dupo, IL (US)

(73) Assignee: MASTERCARD INTERNATIONAL INCORPORATED, Purchase, NY (US)

(21) Appl. No.: 13/741,547

(22) Filed: Jan. 15, 2013

Related U.S. Application Data
(60) Provisional application No. 61/719,265, filed on Oct. 26, 2012.

(51) Int. Cl. G06Q 20/40

(52) U.S. Cl. CPC G06Q 20/409
USPC 705/44

(57) ABSTRACT

Computer systems and methods for managing the investigation of potentially fraudulent payment card transactions are provided. The computer system includes a memory device for storing data and a processor in communication with the memory device. The computer system is programmed to receive an authorization request message associated with at least one transaction initiated with a payment card. The computer system transmits a scoring request message associated with the at least one transaction to a fraud scoring system. The computer system receives a fraud scoring response associated with the at least one transaction from the fraud scoring system. The fraud scoring response includes a first instruction directing a change to a status of the payment card. The computer system transmits a status change message to a cardholder management system.

### CROSS-REFERENCE TO RELATED APPLICATIONS

This application claims the priority of U.S. Provisional Patent Application Ser. No. 61/719,265, filed Oct. 26, 2012, which is incorporated herein by reference.

### BACKGROUND OF THE INVENTION

The field of the invention relates generally to methods and systems for investigating fraudulent transactions and, more particularly, to computer-implemented methods and systems for identifying a payment card transaction as being potentially fraudulent, and modifying a status of the transaction card until the transaction is reviewed. Issuers of payment cards face lost revenue and significant costs for fraudulent transactions. At least some known fraud detection systems are used by payment card issuers for detecting at least some fraudulent transactions initiated over a payment card network. These known fraud detection systems use different processes and/or models to detect fraud. Once a transaction is designated as a fraudulent transaction, in at least some known cases, a human analyst investigates the case to determine whether further steps should be taken.

It would be desirable to provide an automated system that, upon a transaction being marked as potentially fraudulent, can automatically take steps to stop the current transaction and subsequent transactions until the current transaction is properly investigated. It would further be desirable to provide an automated system that can modify the status of a payment card in order to block further transactions while the suspected fraudulent activity is further investigated.

### BRIEF DESCRIPTION OF THE INVENTION

In one embodiment, a computer system for modifying a status of a payment card is provided. The computer system includes a memory device for storing data and a processor in communication with the memory device. The processor is programmed to receive an authorization request message associated with a first transaction initiated with a payment card. The processor is further programmed to transmit a scoring request message associated with the first transaction to a fraud scoring system. The processor is further programmed to receive a fraud scoring response message associated with the first transaction from the fraud scoring system, the fraud scoring response message including a first instruction directing a change to a status of the payment card. The processor is further programmed to generate a status change message based on the first instruction and transmit the status change message to a cardholder management system.

In another embodiment, a computer-implemented method for modifying a status of a payment card is provided, wherein the method uses a computer device that includes a memory device and a processor. The method includes receiving an authorization request message associated with a first transaction initiated with a payment card. The method further includes transmitting a scoring request message associated with the first transaction to a fraud scoring system. The method further includes receiving a fraud scoring response message associated with the first transaction from the fraud scoring system, the fraud scoring response message including a first instruction directing a change to a status of the payment card. The method further includes generating a status change message based on the first instruction and transmitting the status change message to a cardholder management system.

In yet another embodiment, one or more non-transitory computer readable storage media having computer-executable instructions embodied thereon for modifying a status of a payment card using a computing device are provided. The computing device includes a memory device and a processor. The computer-executable instructions cause the processor to receive an authorization request message associated with a first transaction initiated with a payment card. The computer-executable instructions further cause the processor to transmit a scoring request message associated with the first transaction to a fraud scoring system. The computer-executable instructions further cause the processor to receive a fraud scoring response message associated with the first transaction from the fraud scoring system, the fraud scoring response message including a first instruction directing a change to a status of the payment card. The computer-executable instructions further cause the processor to generate a status change message based on the first instruction and transmit the status change message to a cardholder management system.

### BRIEF DESCRIPTION OF THE DRAWINGS

FIG. 1 is a schematic diagram illustrating an exemplary multi-party payment card industry system for enabling ordinary payment transactions in which merchants and card issuers do not necessarily have a one-to-one relationship.

FIG. 2 is a simplified block diagram of an exemplary payment processing system, including a fraud management platform in accordance with one embodiment of the present invention.

FIG. 3 is an expanded block diagram of an exemplary embodiment of a server architecture of a payment processing system including the fraud management platform shown in FIG. 2 in accordance with one embodiment of the present invention.

FIG. 4 illustrates an exemplary configuration of a client system shown in FIGS. 2 and 3.

FIG. 5 illustrates an exemplary configuration of a server system shown in FIGS. 2 and 3.

FIG. 6 is a simplified block diagram showing the flow of communications between the payment network shown in FIG. 1, and the fraud management platform shown in FIG. 2.

FIG. 7 is a flowchart illustrating an exemplary method for modifying a status of a payment card, in accordance with an exemplary embodiment of the invention.

### DETAILED DESCRIPTION OF THE INVENTION

Embodiments of the present invention herein relate generally to a system for modifying a status of a payment card, as part of processing potentially fraudulent payment card transactions over a payment card network. The system includes an authorization system, a fraud scoring system, and a cardholder management system.

In operation, when a cardholder initiates a transaction by swiping a payment card or using a payment card over the payment card network, an authorization request message for the transaction is transmitted over the payment card network to an authorization system for authorization of the transaction. The fraud scoring system receives the authorization request message, including the transaction information, on behalf of the fraud management platform. The fraud scoring system may use a variety of fraud scoring algorithms to generate a fraud score for the transaction, indicating the likelihood that the transaction is fraudulent. In addition, or alternatively, the payment card issuer may have predefined business rules, the violation of one or more of which results in a determination that a transaction is fraudulent or at a high risk of being fraudulent. If the fraud score generated by the fraud scoring system meets a threshold level (i.e., that the transaction is potentially fraudulent), and/or if one or more specific applicable business rules have been violated, the fraud scoring system creates a fraud scoring response message. As used herein, “fraud scoring response message” refers to a response based either on a particular score value that has been determined by the fraud scoring system, or based on a violation of one or more specific business rules, or both. The response message includes a first instruction and a second instruction, which may appear in any order in the response message. The first instruction of the response message includes a modify status of payment card instruction. The second instruction of the response message includes an approve or a decline response relating to the transaction. In other words, in a case where the fraud scoring system scores a transaction above the threshold for potentially fraudulent (i.e., the fraud scoring engine determines that the transaction is potentially fraudulent), the fraud scoring engine transmits a response message to the authorization system, wherein the response message includes two instructions. The first instruction of the response message is to modify the status of payment card from ACTIVE to “Suspended,” and the second instruction of the response message is to decline the present transaction. The authorization system transmits the status change message to a cardholder management system. The cardholder management system then changes the status of the payment card, e.g., from ACTIVE to SUSPENDED in response to the status change message, so that the payment card cannot be used in any further transactions until the current transaction is properly investigated. While a status change from ACTIVE to SUSPENDED is described in the exemplary embodiment, in alternative embodiments, changes between other status states may be performed, as needed to place the card in any applicable predefined status that is desired.

The order of execution or performance of the operations in the embodiments of the invention illustrated and described herein is not essential, unless otherwise specified. That is, the operations described herein may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

The methods and systems described herein may be implemented using computer programming or engineering techniques including computer software, firmware, hardware or any combination or subset thereof, wherein the technical effect may be achieved by performing at least one of the following steps: (a) receiving an authorization request message associated with a first transaction initiated with a payment card; (b) transmitting a scoring request message associated with the first transaction to a fraud scoring system; (c) receiving a fraud scoring response message associated with the first transaction from the fraud scoring system, the fraud scoring response message including a first instruction directing a change to a status of the payment card and a second instruction declining the first transaction; (d) generating a status change message based on the first instruction and transmitting the status change message to a cardholder management system; (e) updating a local card status in response to the fraud scoring response received from the fraud scoring system; (f) changing a status of a payment card stored within a database in the cardholder management system in response to the generated status change message; (g) designating a case representing the at least one transaction, for further investigation; and (h) automatically declining a second transaction, after receipt of the first instruction directing the status of the payment card to be changed from ACTIVE to SUSPENDED.

As used herein, the terms “payment card,” “financial transaction card,” and “transaction card” refer to any suitable payment card, such as a credit card, a debit card, a prepaid card, a charge card, a membership card, a promotional card, a frequent flyer card, an identification card, a gift card, and/or any other device that may hold payment account information, such as mobile phones, smartphones, personal digital assistants (PDAs), key fobs, and/or computers. Each type of payment card can be used as a method of payment for performing a transaction. In addition, cardholder account behavior can include but is not limited to purchases, management activities (e.g. balance checking), bill payments, achievement of targets (meeting account balance goals, paying bills on time), and/or product registrations (e.g. mobile application downloads).

In one embodiment, a computer program is provided, and the program is embodied on a computer readable medium. In an exemplary embodiment, the system is executed on a single computer system, without requiring a connection to a sever computer. In a further exemplary embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

The following detailed description illustrates embodiments of the invention by way of example and not by way of limitation. It is contemplated that the invention has general application to processing financial transaction data by a third party in a variety of applications.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present invention are not intended to be interpreted as excluding the existence of additional embodiments that also incorporate the recited features.

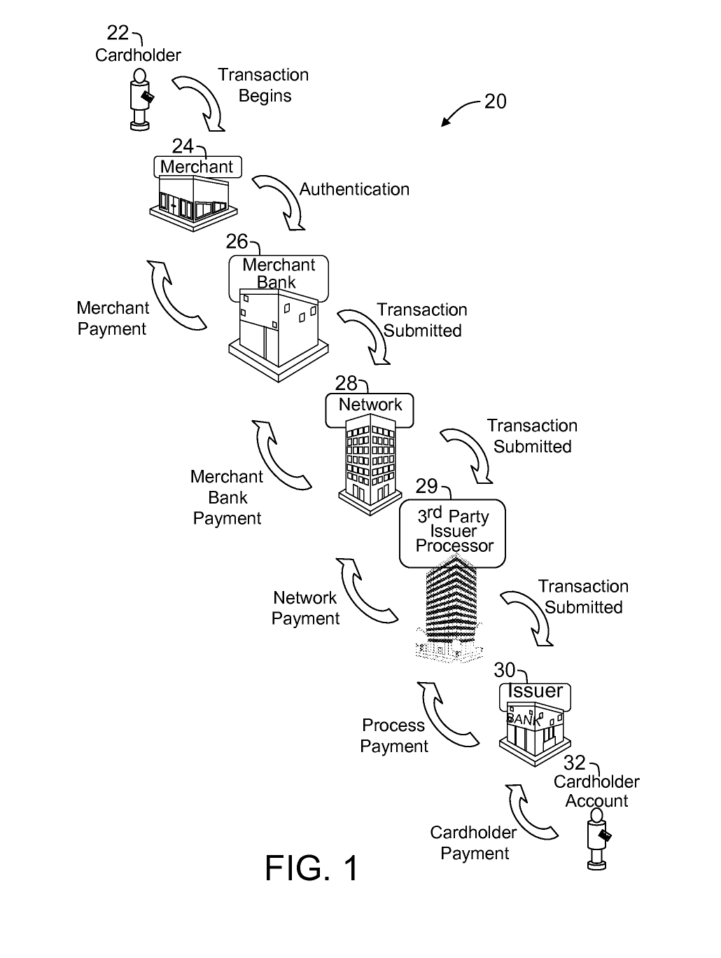

FIG. 1 is a schematic diagram illustrating an exemplary multi-party payment card industry system 20 for enabling ordinary payment-by-card transactions in which merchants 24 and card issuers 30 do not need to have a one-to-one special relationship. Embodiments described herein may relate to a payment card system, such as a credit card payment system using the MasterCard® interchange network (MasterCard is a registered trademark of MasterCard International Incorporated located in Purchase, New York). The MasterCard interchange network is a set of proprietary communications standards promulgated by MasterCard International Incorporated for the exchange of financial transaction data and the settlement of funds between financial institutions that are members of MasterCard International Incorporated. In a typical payment card system, a financial institution called the “issuer” issues a payment card, such as a credit card, to a consumer or cardholder 22, who uses the payment card to tender payment for a purchase from a merchant 24. To accept payment with the payment card, merchant 24 must normally establish an account with a financial institution that is part of the financial payment system. This financial institution is usually called the “merchant bank,” the “acquiring bank,” or the “acquirer.” When cardholder 22 tenders payment for a purchase with a payment card, merchant 24 sends an authorization request message to a merchant bank 26 for the amount of the purchase. The request may be performed over the telephone, but is usually performed through the use of a point-of-sale device, which reads cardholder's 22 account information from a magnetic stripe, a chip, or embossed characters on the payment card and communicates electronically with the transaction processing computers of merchant bank 26. Alternatively, merchant bank 26 may authorize a third party to perform transaction processing on its behalf. In this case, the point-of-sale device will be configured to communicate with the third party. Such a third party is usually called a “merchant processor,” an “acquiring processor,” or a “third party processor.”

Using an interchange network 28, computers of merchant bank 26 will communicate transaction information with computers of an issuer processor 29 associated with an issuer 30. Issuer processor 29 may be a third party processor authorized to perform transaction-related services on behalf of issuer 30, including payment card production services, payment card processing services, fraud detection services, data delivery services, ATM driving services, transaction research, and cardholder support services. Issuer processor 29 may also provide interbank switch processing, including authorization, clearing and settlement, and value-added services. This enables issuer 30 to use one card processor for all different payment card brands. In an alternative embodiment, issuer processor 29 may be associated with interchange network 28 and may provide similar services.

Issuer 30 receives the transaction information from issuer processor 29, and then determines whether cardholder's 22 account 32 is in good standing and whether the purchase is covered by cardholder's 22 available credit limit. Based on these determinations, the request for authorization will be declined or accepted. If the request is accepted, an authorization code is issued to merchant 24.

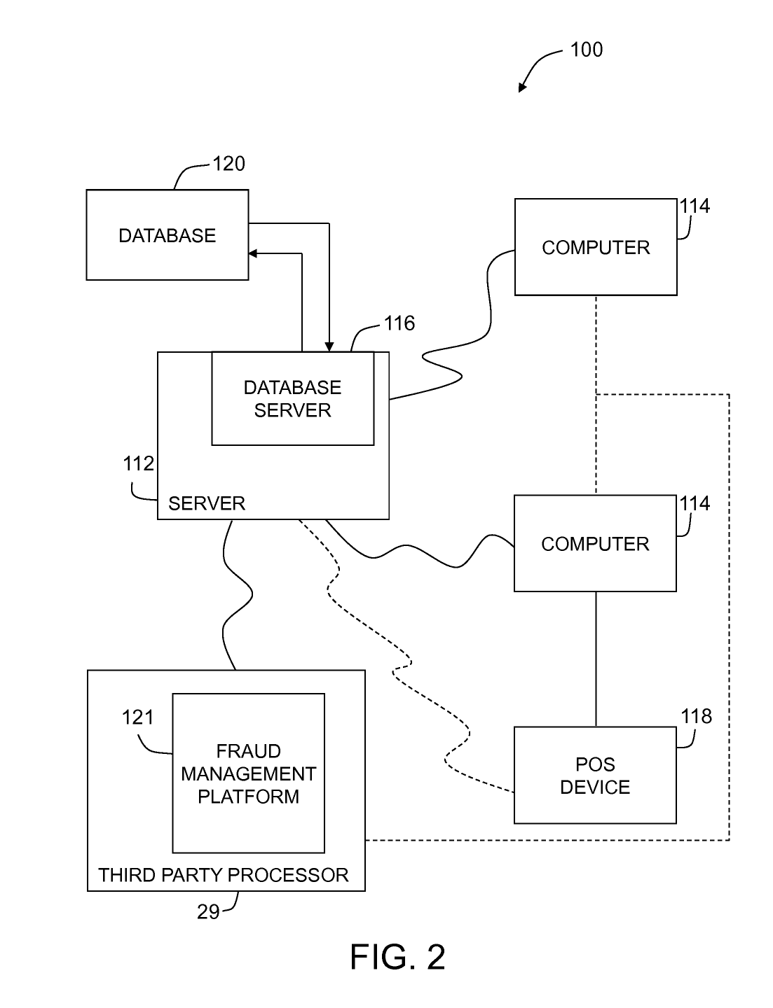

When a request for authorization is accepted, the available credit line of cardholder's 22 account 32 is decreased. Normally, a charge for a payment card transaction is not posted immediately to cardholder's 22 account 32 because bankcard associations, such as MasterCard International Incorporated®, have promulgated rules that do not allow merchant 24 to charge, or “capture,” a transaction until goods are shipped or services are delivered. However, with respect to at least some debit card transactions, a charge may be posted at the time of the transaction. When merchant 24 ships or delivers the goods or services, merchant 24 captures the transaction by, for example, appropriate data entry procedures on the point-of-sale device. This may include bundling of approved transactions daily for standard retail purchases. If cardholder 22 cancels a transaction before it is captured, a “void” is generated. If cardholder 22 returns goods after the transaction has been captured, a “credit” is generated. Interchange network 28 and/or issuer 30 stores the payment card information, such as a type of merchant, amount of purchase, date of purchase, in a database 120 (shown in FIG. 2).

After a purchase has been made, a clearing process occurs to transfer additional transaction data related to the purchase among the parties to the transaction, such as merchant bank 26, interchange network 28, issuer processor 29, and issuer 30. More specifically, during and/or after the clearing process, additional data, such as a time of purchase, a merchant name, a type of merchant, purchase information, cardholder account information, a type of transaction, itinerary information, information regarding the purchased item and/or service, and/or other suitable information, is associated with a transaction and transmitted between parties to the transaction as transaction data, and may be stored by any of the parties to the transaction.

After a transaction is authorized and cleared, the transaction is settled among merchant 24, merchant bank 26, interchange network 28, issuer processor 29, and issuer 30. Settlement refers to the transfer of financial data or funds among merchant's 24 account, merchant bank 26, issuer processor 29, and issuer 30 related to the transaction. Usually, transactions are captured and accumulated into a “batch,” which is settled as a group. More specifically, a transaction is typically settled between issuer 30 and issuer processor 29, and then between issuer processor 29 and interchange network 28, and then between interchange network 28 and merchant bank 26, and then between merchant bank 26 and merchant 24.

FIG. 2 is a simplified block diagram of an exemplary payment processing system 100 including a fraud management platform 121 in accordance with one embodiment of the present invention. In the example embodiment, system 100 is configured to process payment-by-card transactions, determine whether a transaction is potentially fraudulent, open a case for a potentially fraudulent transaction, decline to complete the potentially fraudulent transaction, and automatically instruct the system to modify the status of the payment card from ACTIVE to SUSPENDED until the transaction can be properly investigated.

More specifically, in the example embodiment, system 100 includes a server system 112, and a plurality of client sub-systems, also referred to as client systems 114, connected to server system 112. In one embodiment, client systems 114 are computers including a web browser, such that server system 112 is accessible to client systems 114 using the Internet. Client systems 114 are interconnected to the Internet through many interfaces including a network, such as a local area network (LAN) or a wide area network (WAN), dial-in-connections, cable modems, and special high-speed Integrated Services Digital Network (ISDN) lines. Client systems 114 could be any device capable of interconnecting to the Internet including a web-based phone, PDA, or other web-based connectable equipment.

System 100 also includes a point-of-sale (POS) device 118, which may be connected to client systems 114, and may be connected to server system 112. POS device 118 is interconnected to the Internet through many interfaces including a network, such as a LAN or a WAN, dial-in-connections, cable modems, wireless modems, and/or special high-speed ISDN lines. POS device 118 can be any device capable of interconnecting to the Internet and includes an input device capable of reading information from a cardholder's payment card.

A database server 116 is connected to a database 120, which contains information on a variety of matters, as described below in greater detail. In one embodiment, database 120 is stored on centralized server system 112 and can be accessed by potential users at one of client systems 114 by logging onto server system 112 through one of client systems 114. In an alternative embodiment, database 120 is stored remotely from server system 112 and may be non-centralized.

Database 120 may include a single database having separated sections or partitions or may include multiple databases, each being separate from each other. Database 120 may store transaction data generated as part of sales activities conducted over the processing network including data relating to merchants, account holders or customers, issuers, acquirers, and/or purchases made. Database 120 may also store cardholder account data including a name, an address, an account number, and other account identifier. Database 120 may also store merchant data including a merchant identifier that identifies each merchant registered to use the network, and instructions for settling transactions including merchant bank account information. Database 120 may also store purchase data associated with items being purchased by a cardholder from a merchant, and authorization request message data.

System 100 may also include a fraud management platform 121, which may be connected to one or more client systems 114, and may be connected to server system 112. Fraud management platform 121 is interconnected to the Internet through many interfaces including a network, such as a LAN or a WAN, dial-in-connections, cable modems, wireless modems, and/or special high-speed ISDN lines. In one embodiment, fraud management platform 121 is located remotely from server system 112 and may be non-centralized. In an alternative embodiment, fraud management platform 121 is located on server system 112 and can be accessed by potential users at one of client systems 114 by logging onto server system 112 through one of client systems 114. Fraud management platform 121 is capable of detecting, scoring, processing, verifying, storing information accumulated during review of a payment card transaction with a cardholder, and automatically modifying the status of a payment card involved in a potentially fraudulent transaction. In the exemplary embodiment, fraud management platform 121 is one of many functions provided by third party processor 29 (see FIG. 1). As described above, third party processor 29 is part of interchange network 28. In an alternative embodiment, third party processor 29 is separate from interchange network 28.

In the exemplary embodiment, one of client systems 114 may be associated with merchant bank 26 (shown in FIG. 1) while another one of client systems 114 may be associated with issuer 30 (shown in FIG. 1). POS device 118 is associated with a participating merchant 24 (shown in FIG. 1) or may be a computer system and/or mobile system used by cardholder 22 (shown in FIG. 1) making an on-line purchase or payment. Fraud management platform 121 is associated with a payment card network, such as interchange network 28 (shown in FIG. 1), or may be associated with issuer processor 29 (shown in FIG. 1) or issuer 30. In the exemplary embodiment, server system 112 is associated with interchange network 28. Server system 112 may be used for processing transaction data. In addition, client systems 114 and/or POS device 118 may include a computer system associated with at least one of an online bank, a bill payment outsourcer, a merchant bank, a merchant processor, an issuer associated with a payment card, an issuer processor, a remote payment system, and/or a biller.

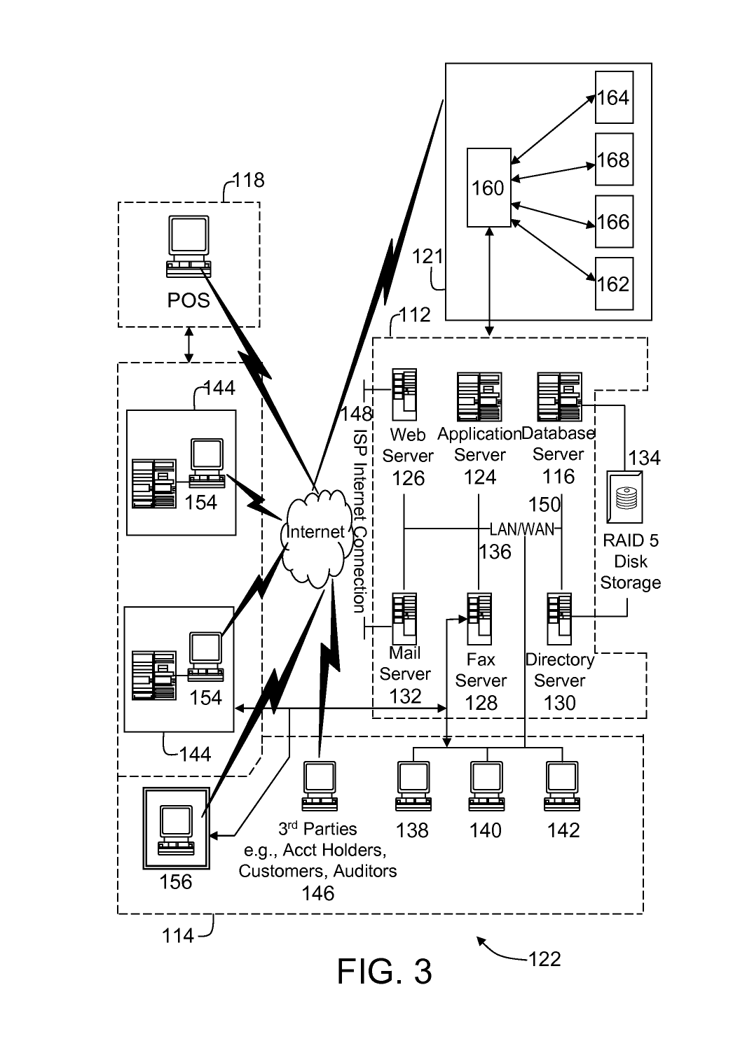

FIG. 3 is an expanded block diagram of an exemplary embodiment of a server architecture of a payment processing system 122 including fraud management platform 121 in accordance with one embodiment of the present invention. Components in system 122, identical to components of system 100 (shown in FIG. 2), are identified in FIG. 3 using the same reference numerals as used in FIG. 2. System 122 includes server system 112, client systems 114, POS device 118, and fraud management platform 121. Server system 112 further includes database server 116, an application server 124, a web server 126, a fax server 128, a directory server 130, and a mail server 132. A storage device 134 is coupled to database server 116 and directory server 130. Servers 116, 124, 126, 128, 130, and 132 are coupled in a LAN 136. In addition, a system administrator's workstation 138, a user workstation 140, and a supervisor's workstation 142 are coupled to LAN 136. Alternatively, workstations 138, 140, and 142 are coupled to LAN 136 using an Internet link or are connected through the Intranet.

Each workstation 138, 140, and 142 is a personal computer having a web browser. Although the functions performed at the workstations typically are illustrated as being performed at respective workstations 138, 140, and 142, such functions can be performed at one of many personal computers coupled to LAN 136. Workstations 138, 140, and 142 are illustrated as being associated with separate functions only to facilitate an understanding of the different types of functions that can be performed by individuals having access to LAN 136.

Server system 112 is configured to be communicatively coupled to various individuals, including employees 144 and third parties, e.g., account holders, customers, auditors, developers, consumers, merchants, acquirers, issuers, etc., 146 using an ISP Internet connection 148. The communication in the exemplary embodiment is illustrated as being performed using the Internet, however, any other WAN type communication can be utilized in other embodiments, i.e., the systems and processes are not limited to being practiced using the Internet. In addition, and rather than WAN 150, LAN 136 could be used in place of WAN 150.

In the exemplary embodiment, any authorized individual having a workstation 154 can access system 122. At least one of client systems 114 includes a manager workstation 156 located at a remote location. Workstations 154 and 156 are personal computers having a web browser. Also, workstations 154 and 156 are configured to communicate with server system 112. Furthermore, fax server 128 communicates with remotely located client systems, including a client system 156 using a telephone link. Fax server 128 is configured to communicate with other client systems 138, 140, and 142 as well.

In the exemplary embodiment, fraud management platform 121 is in communication with server system 112 and/or client systems 114 and other workstations through a network connection. In the exemplary embodiment, fraud management platform 121 includes an automated analysis system 160 that acts as an interface between a fraud scoring system 162, a contact management system 164, and a cardholder management system 166. In an alternative embodiment, fraud management platform 121 also includes an issuer interface 168 in communication with automated analysis system 160. As described above, fraud management platform 121 is one of a number of functions provided by third party processor 29 (see FIG. 1).

In the exemplary embodiment, fraud management platform 121 is associated with a payment card network, such as interchange network 28 (shown in FIG. 1). Specifically, in the exemplary embodiment, fraud management platform 121 is associated with a third-party payment processor, such as issuer processor 29 (shown in FIG. 1). Fraud management platform 121 includes automated analysis system 160, fraud scoring system 162, contact management system 164, and cardholder management system 166. In an alternative embodiment, fraud management platform 121 also includes issuer interface 168. Automated analysis system 160 serves as an automatic interface, linking multiple, separate systems used for detecting, scoring, processing, verifying, and storing information accumulated during review of a payment card transaction with a cardholder. Automated analysis system 160 serves as an interface between fraud scoring system 162, contact management system 164, and cardholder management system 166.

Fraud scoring system 162 is configured to validate payment card transactions by providing real-time or near real-time fraud scores that indicate the likelihood that a transaction is fraudulent. In the exemplary embodiment, fraud scoring is offered as part of a payment card network's services when processing transaction data. When an authorization request message is received by the payment card network, the network determines whether the merchant bank and/or issuer have subscribed to the fraud scoring service offered by fraud scoring system 162. If so, the transaction data is transmitted to fraud scoring system 162 to calculate a fraud score for the transaction and determine if it is potentially fraudulent.

Fraud scoring system 162 implements a set of rules or criteria that define a transaction by various characteristics associated with the transaction. The criteria may include the amount and the location of a transaction, the type of goods, the type of merchant, and/or the value of the fraud score. When a transaction meets a threshold of the criteria, fraud scoring system 162 creates a case, indicating the transaction is potentially fraudulent and needs further review by an analyst. Based on predetermined criteria, when a transaction is marked as potentially fraudulent, fraud scoring system 162 decides whether to decline the transaction, or approve the transaction and create a case to be analyzed. When fraud scoring system 162 decides to approve the transaction and create a case, fraud scoring system 162 associates the case with at least one queue and stores the case in a database. In the exemplary embodiment, fraud scoring system 162 is FICO™ Falcon™ Fraud Manager (FICO and FALCON are both trademarks of FICO, of Minneapolis, Minn.).

Cardholder management system 166 includes a database associated with a payment card network that stores cardholder card and contact information. The database also stores information regarding the status of cardholder cards, specifically whether a card is ACTIVE or SUSPENDED. The information stored in the database is provided by a potential cardholder upon application for a payment card. Cardholder management system 166 communicates directly or indirectly with contact management system 164 to provide a cardholder's card and contact information as described above, as required.

In an alternative embodiment, fraud management platform 121 includes issuer interface 168. Issuer interface 168 enables fraud management platform 121 to access a database associated with a payment card issuer that chooses to manage its clients' information separately from the payment card network. The database may contain additional contact information. Issuer interface 168 provides payment card issuer information to contact management system 164 as required. If any cardholder information is missing or inconsistent with the data in cardholder management system 166, the data in the issuer's database may supplement or override the information stored in cardholder management system 166. If the issuer chooses for its information to control inconsistencies, cardholder management system 166 may be updated to contain the correct or additional cardholder information.

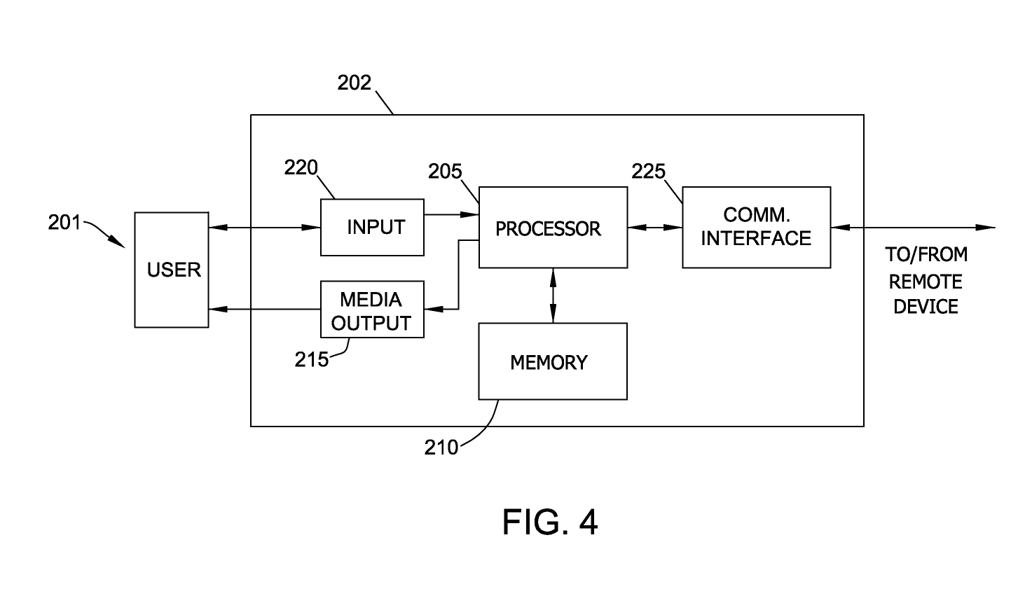

FIG. 4 illustrates an exemplary configuration of a user system 202 operated by a user 201 in accordance with one embodiment of the present invention. User system 202 may include, but is not limited to, fraud management platform 121, client systems 114, 138, 140, and 142, POS device 118, workstation 154, and manager workstation 156 (all shown in FIG. 3). In the exemplary embodiment, user system 202 includes a processor 205 for executing instructions. In some embodiments, executable instructions are stored in a memory area 210. Processor 205 may include one or more processing units, for example, a multi-core configuration. Memory area 210 is any device allowing information such as executable instructions and/or written works to be stored and retrieved. Memory area 210 may include one or more computer readable media.

User system 202 also includes at least one media output component 215 for presenting information to user 201. Media output component 215 is any component capable of conveying information to user 201. In some embodiments, media output component 215 includes an output adapter such as a video adapter and/or an audio adapter. An output adapter is operatively coupled to processor 205 and operatively coupleable to an output device such as a display device, a liquid crystal display (LCD), organic light emitting diode (OLED) display, or “electronic ink” display, or an audio output device, a speaker or headphones.

In some embodiments, user system 202 includes an input device 220 for receiving input from user 201. Input device 220 may include, for example, a keyboard, a pointing device, a mouse, a stylus, a touch sensitive panel, a touch pad, a touch screen, a gyroscope, an accelerometer, a position detector, or an audio input device. A single component such as a touch screen may function as both an output device of media output component 215 and input device 220. User system 202 may also include a communication interface 225, which is communicatively coupleable to a remote device such as server system 112. Communication interface 225 may include, for example, a wired or wireless network adapter or a wireless data transceiver for use with a mobile phone network, Global System for Mobile communications (GSM), 3G, 4G, or other mobile data network or Worldwide Interoperability for Microwave Access (WIMAX).

Stored in memory area 210 are, for example, computer readable instructions for providing a user interface to user 201 via media output component 215 and, optionally, receiving and processing input from input device 220. A user interface may include, among other possibilities, a web browser and client application. Web browsers enable users, such as user 201, to display and interact with media and other information typically embedded on a web page or a website from server system 112. A client application allows user 201 to interact with a server application from server system 112.

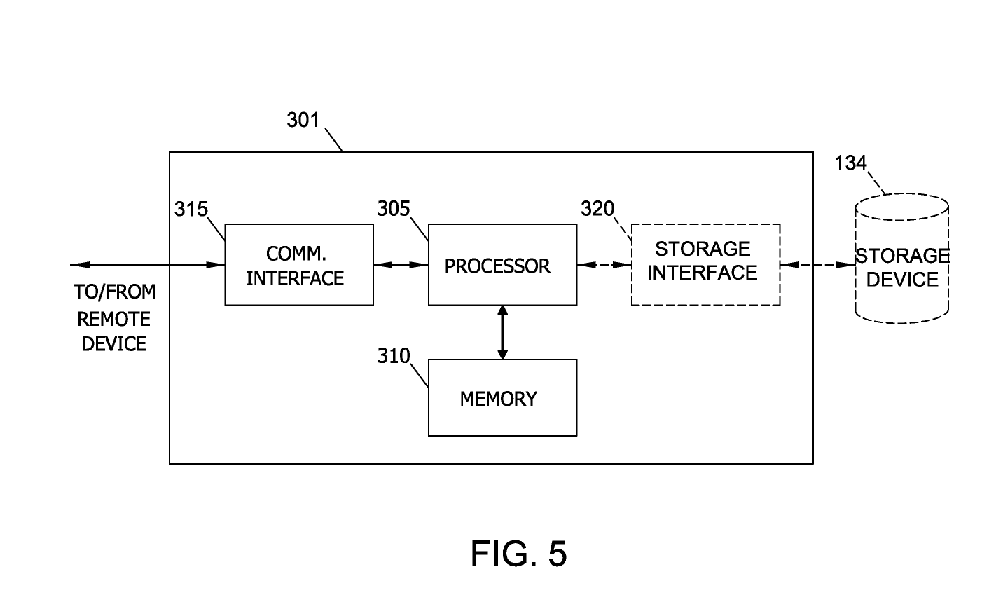

FIG. 5 illustrates an exemplary configuration of a server system 301, such as server system 112 (shown in FIGS. 2 and 3). Server system 301 may include, but is not limited to, database server 116, application server 124, web server 126, fax server 128, directory server 130, and mail server 132.

Server system 301 includes a processor 305 for executing instructions. Instructions may be stored in a memory area 310, for example. Processor 305 may include one or more processing units (e.g., in a multi-core configuration) for executing instructions. The instructions may be executed within a variety of different operating systems on the server system 301, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 305 is operatively coupled to a communication interface 315 such that server system 301 is capable of communicating with a remote device such as a user system or another server system 301. For example, communication interface 315 may receive requests from user system 114 via the Internet, as illustrated in FIGS. 2 and 3.

Processor 305 may also be operatively coupled to a storage device 134. Storage device 134 is any computer-operated hardware suitable for storing and/or retrieving data. In some embodiments, storage device 134 is integrated in server system 301. For example, server system 301 may include one or more hard disk drives as storage device 134. In other embodiments, storage device 134 is external to server system 301 and may be accessed by a plurality of server systems 301. For example, storage device 134 may include multiple storage units such as hard disks or solid state disks in a redundant array of inexpensive disks (RAID) configuration. Storage device 134 may include a storage area network (SAN) and/or a network attached storage (NAS) system.

In some embodiments, processor 305 is operatively coupled to storage device 134 via a storage interface 320. Storage interface 320 is any component capable of providing processor 305 with access to storage device 134. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 134.

Memory area 310 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

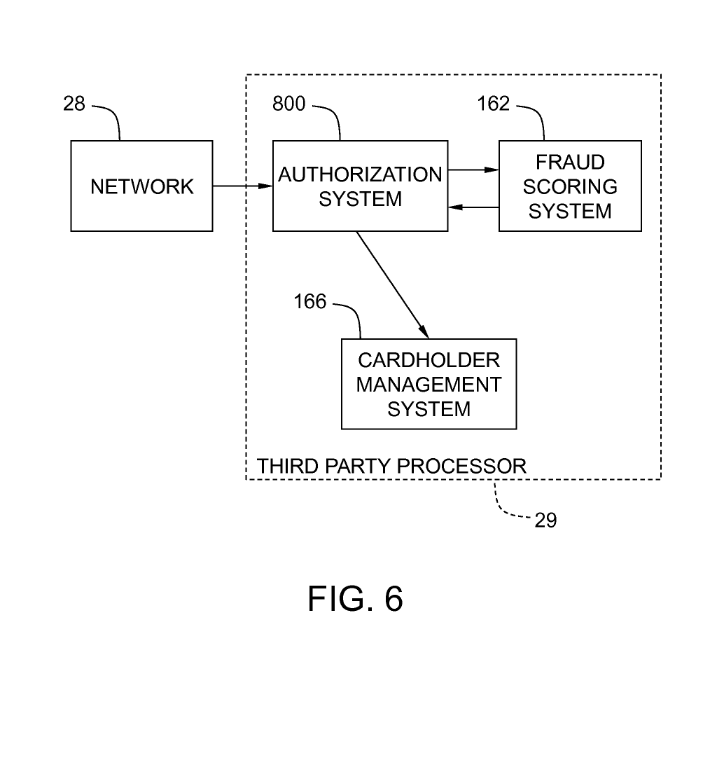

FIG. 6 is a simplified block diagram illustrating the flow of communications between interchange network 28, and fraud management platform 121 (as represented by authorization system 800, fraud scoring system 162, and cardholder management system 166). In an exemplary embodiment of the invention, the functions of authorization system 800 are performed by server system 112 (illustrated in FIGS. 2 and 3), which may be part of a payment processing system 100. The functions of authorization system 800 may be performed by an issuer processor 29 (as described above and shown in FIG. 1). Fraud scoring system 162 and cardholder management system 166 are part of fraud management platform 121, as described above with respect to FIG. 3. As described, in the exemplary embodiment, fraud management platform 121 is a function of third party processor 29 (shown in FIG. 1).

In operation, fraud management platform 121 receives an authorization request message, including the transaction data, for a payment card transaction from an interchange network 28. Fraud scoring system 162 (shown in FIGS. 3 and 6) receives and processes the incoming authorization request message to calculate a fraud score for the transaction, representing the likelihood that the transaction is fraudulent. If the fraud score meets a predetermined threshold level, fraud scoring system 162 creates a case for the transaction. Fraud scoring system 162 then associates the case with one or more queues in a database of fraud scoring system 162. Each queue includes cases having similar characteristics, such as time and location of the transaction, type of merchant or goods, and overall fraud score. Cases placed in a queue are analyzed by either a human or fraud management platform 121. In the exemplary embodiment, fraud management platform 121 is further configured to make changes to the status of a payment card in response to a fraud score determination made by fraud scoring system 162.

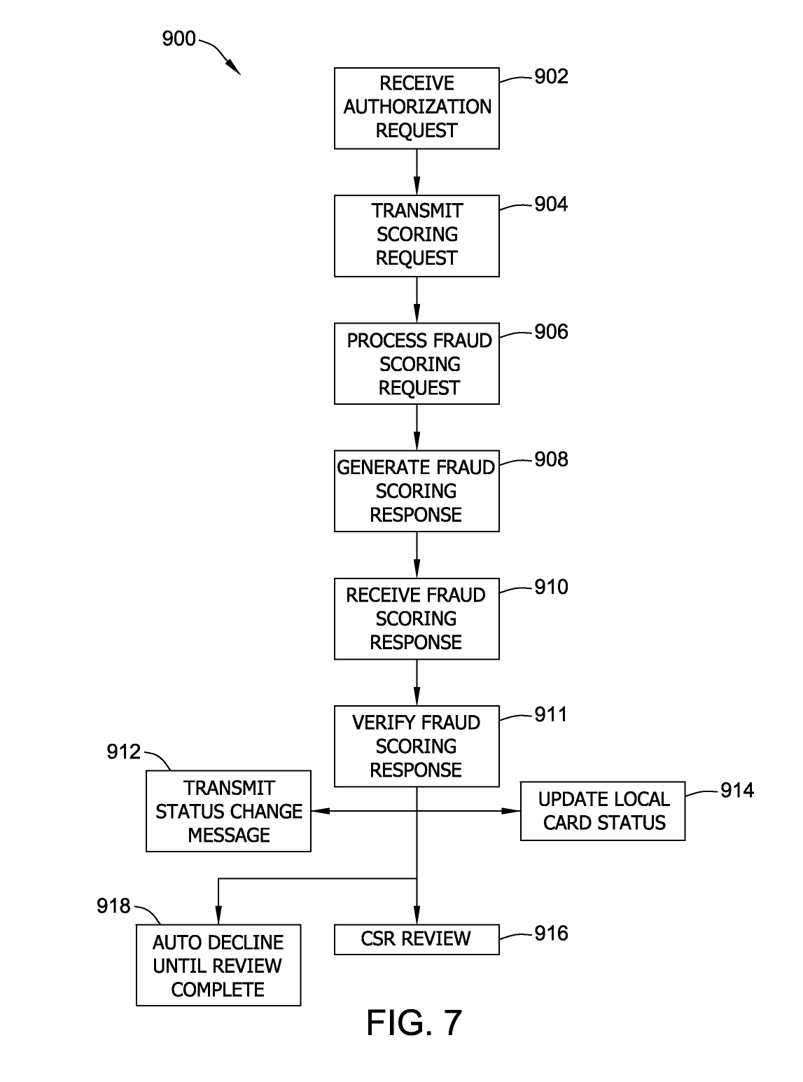

FIG. 7 is a flowchart illustrating a method 900 for modifying the status of a payment card. Authorization system 800 receives 902 an authorization request message from an ATM or interchange network 28 (shown in FIG. 1) relating to a proposed transaction involving a payment card. Authorization system 800 transmits 904 a scoring request message to fraud scoring system 162. Fraud scoring system 162 processes 906 the scoring request message, as described above with respect to FIG. 7. If the fraud score is at or below a predetermined threshold level, fraud scoring system responds to authorization system 800 with a message indicating approval of the transaction. If the fraud score exceeds a predetermined threshold level, fraud scoring system 162 generates 908 a response, indicating that the transaction is declined, that is received by authorization system 800. In addition to an instruction declining the transaction, the response to the scoring request message includes another instruction directing that the status of the payment card in question be changed, e.g., from ACTIVE to SUSPENDED. In an alternative embodiment, the first fraud score threshold level which prompts the generation and transmission of a “transaction declined” instruction is different from, and lower than, a second fraud score threshold level which prompts the generation and transmission of an instruction directing that the status of the payment card be changed.

Upon receipt 910 of the fraud scoring response from fraud scoring system 162, authorization system 800 verifies 911 the fraud scoring response, and generates and transmits 912 a real-time status change message to cardholder management system 166 directing cardholder management system 166 to immediately change the status of the payment card from ACTIVE to SUSPENDED in the appropriate database(s). Authorization system 800 also updates 914 a local card status (i.e., the real-time status of the payment card as identified within authorization system 800). That is, the SUSPENDED status of the card is reported to the commercial establishment from which the potentially fraudulent transaction originated, to preclude second or subsequent attempts at completion of the transaction. Further, authorization system 800 creates 916 a case for subsequent review of the suspended status of the payment card, by a Customer Service Representative (CSR) associated with authorization system 800. Authorization system 800 further automatically declines 918 any subsequent transactions attempted with the payment card in question, until the potentially fraudulent transaction investigation has been completed. In the exemplary embodiment of the invention, following change of the local status of the payment card within authorization system 800 to SUSPENDED, subsequent attempts to complete transactions using the suspected payment card result in an automatic DECLINE response, without transmission of a fraud score request message to fraud scoring system 162.

In the exemplary embodiment, fraud scoring system 162 is configured to transmit a response which includes an instruction directing that a payment card status be changed from ACTIVE to SUSPENDED. In an alternative embodiment, fraud scoring system 162 is configured such that if the score is determined to exceed a different, e.g., higher, threshold level, fraud scoring system 162 generates a response which directs that the status of the payment card is to be changed, e.g., from ACTIVE to TERMINATED or the like, the difference being that a card may be reactivated from a SUSPENDED status, while a card that has been assigned a TERMINATED status may not be reactivated.

In the exemplary embodiment, the steps of method 900 are performed by payment system 100 and the associated facilities in real or near-real time, so that a DECLINE response message is received at a commercial establishment while the consumer and/or salesperson attempting the transaction is/are still at the checkout location, for example. By “near-real time,” it is meant that a response is received within thirty (30) seconds of transmission of the authorization request message, and preferably within ten to fifteen (10-15) seconds of transmission of the authorization request message.

The above-described methods and systems provide for automatic investigation of fraudulent transactions by a payment card issuer processor. The methods and systems described herein facilitate automatically implementing and managing an investigation of a payment card transaction marked as potentially fraudulent, communicating with the cardholder for transaction verification, and updating a fraud scoring system with the result of the investigation to assist in preventing subsequent fraudulent transactions.

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are exemplary only, and are thus not limiting as to the types of memory usable for storage of a computer program.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A computer system for modifying a status of a payment card, said computer system comprising:
a memory device for storing data; and
a processor in communication with said memory device, said processor programmed to:
receive an authorization request message associated with a first transaction initiated with a payment card;
transmit a scoring request message associated with the first transaction to a fraud scoring system;
receive a fraud scoring response message associated with the first transaction from the fraud scoring system, the fraud scoring response message including a first instruction directing a change to a status of the payment card from ACTIVE to SUSPENDED;
generate a status change message based on the first instruction and transmitting the status change message to a cardholder management system, wherein the status change message prompts a change in the status of the payment card from ACTIVE to SUSPENDED at the cardholder management system; and,
automatically decline subsequent transactions initiated with the payment card until the status of the payment card is changed from SUSPENDED to ACTIVE.

2. (canceled)

3. A computer system in accordance with claim 1, wherein the fraud scoring response message includes a second instruction declining the first transaction.

4. A computer system in accordance with claim 1, wherein the processor is further programmed to:
update a local card status at a merchant processing system involved in the first transaction in response to the fraud scoring response message; and,
automatically decline subsequent transactions initiated with the payment card before transmitting a scoring request message to the fraud scoring system for any of the subsequent transactions.

5. A computer system in accordance with claim 1, wherein the fraud scoring system generates the first instruction directing the change to the status of the payment card, following a determination of a fraud score in excess of a first predetermined value.

6. A computer system in accordance with claim 5, wherein the fraud scoring system generates the second instruction directing that the at least one transaction be declined, following a determination of a fraud score in excess of a second predetermined value that is less than the first predetermined value.

7. A computer system in accordance with claim 1, wherein the cardholder management system is configured to change the status of the payment card stored within a database in the cardholder management system in response to the generated status change message.

8. A computer system in accordance with claim 1, wherein the processor is further programmed to designate a case representing the at least one transaction, for further investigation.

9. A computer system in accordance with claim 1, wherein the processor is further programmed to automatically decline a second transaction, after receipt of the first instruction directing the status of the payment card to be changed from ACTIVE to SUSPENDED.

10. A computer-implemented method for modifying a status of a payment card using a computer device, wherein the computer device includes a memory device and a processor, said method comprising:
receiving an authorization request message associated with a first transaction initiated with a payment card;
transmitting a scoring request message associated with the first transaction to a fraud scoring system;
receiving a fraud scoring response message associated with the first transaction from the fraud scoring system, the fraud scoring response message including a first instruction directing a change to a status of the payment card from ACTIVE to SUSPENDED;
generating a status change message based on the first instruction and transmitting the status change message to a cardholder management system, wherein the status change message prompts a change in the status of the payment card from ACTIVE to SUSPENDED at the cardholder management system; and
automatically declining subsequent transactions initiated with the payment card until the status of the payment card stored in the cardholder management system is changed from SUSPENDED to ACTIVE.

11. (canceled)

12. A computer-implemented method in accordance with claim 10, wherein the fraud scoring response message includes a second instruction declining the first transaction.

13. A computer-implemented method in accordance with claim 10, said method further comprising:
updating a local card status at a merchant processing system involved in the first transaction in response to the fraud scoring response message; and
automatically declining subsequent transactions initiated with the payment card before transmitting a scoring request message to the fraud scoring system for any of the subsequent transactions.

14. A computer-implemented method in accordance with claim 10, wherein the fraud scoring system generates the first instruction directing a change to the status of the payment card, following a determination of a fraud score in excess of a first predetermined value.

15. A computer-implemented method in accordance with claim 14, wherein the fraud scoring system generates the second instruction directing that the at least one transaction be declined, following a determination of a fraud score in excess of a second predetermined value that is less than the first predetermined value.

16. A computer-implemented method in accordance with claim 10, wherein the cardholder management system is configured to change the status of the payment card stored within a database in the cardholder management system in response to the generated status change message.

17. A computer-implemented method in accordance with claim 10, said method further comprising designating a case representing the at least one transaction, for further investigation.

18. A computer-implemented method in accordance with claim 10, said method further comprising automatically declining a second transaction, after receipt of the first instruction directing the status of the payment card to be changed from ACTIVE to SUSPENDED.

19. One or more non-transitory computer-readable storage media having computer-executable instructions embodied thereon for modifying a status of a payment card using a computing device, wherein the computing device includes a memory device and a processor, wherein when executed by said processor, the computer-executable instructions cause said processor to:
receive an authorization request message associated with a first transaction initiated with a payment card;
transmit a scoring request message associated with the first transaction to a fraud scoring system;
receive a fraud scoring response message associated with the first transaction from the fraud scoring system, the fraud scoring response message including a first instruction directing a change to a status of the payment card from ACTIVE to SUSPENDED;
generate a status change message based on the first instruction and transmitting the status change message to a cardholder management system, wherein the status change message prompts a change in the status of the payment card from ACTIVE to SUSPENDED at the cardholder management system; and,
automatically decline subsequent transactions initiated with the payment card until the status of the payment card is changed from SUSPENDED to ACTIVE.

20. (canceled)

21. The one or more non-transitory computer-readable storage media in accordance with claim 19, wherein the fraud scoring response message includes a second instruction declining the first transaction.

22. The one or more non-transitory computer-readable storage media in accordance with claim 19, wherein the computer-executable instructions further cause the processor to:
update a local card status at a merchant processing system involved in the first transaction in response to the fraud scoring response message; and,
automatically decline subsequent transactions initiated with the payment card before transmitting a scoring request message to the fraud scoring system for any of the subsequent transactions.

23. The one or more non-transitory computer-readable storage media in accordance with claim 19, wherein the fraud scoring system generates the first instruction directing the change to the status of the payment card, following a determination of a fraud score in excess of a first predetermined value.

24. The one or more non-transitory computer-readable storage media in accordance with claim 23, wherein the fraud scoring system generates the second instruction directing that the at least one transaction be declined, following a determination of a fraud score in excess of a second predetermined value that is less than the first predetermined value.

25. The one or more non-transitory computer-readable storage media in accordance with claim 19, wherein the cardholder management system is configured to change the status of the payment card stored within a database in the cardholder management system in response to the generated status change message.

26. The one or more non-transitory computer-readable storage media in accordance with claim 19, wherein the computer-executable instructions further cause the processor to designate a case representing the at least one transaction, for further investigation.

27. The one or more non-transitory computer-readable storage media in accordance with claim 19, wherein the computer-executable instructions further cause the processor to automatically decline a second transaction, after receipt of the first instruction directing the status of the payment card to be changed from ACTIVE to SUSPENDED.
